(19) United States
(12) Patent Application Publication
(10) Pub. No.: US 2016/0307079 A1
(43) Pub. Date: Oct. 20, 2016

(54) METHOD TO VISUALLY REVIEW A PRINT DATA STREAM PRESENT IN A PRINT DATA LANGUAGE

(71) Applicant: Oce Printing Systems GmbH & Co. KG, Poing (DE)

(72) Inventors: Harald Keicher, Isen (DE); Norbert Linkel, Isen (DE); Andreas Haas, Armstorf (DE)

(73) Assignee: Oce Printing Systems GmbH & Co. KG, Poing (DE)

(21) Appl. No.: 15/099,659

(22) Filed: Apr. 15, 2016

(30) Foreign Application Priority Data
Apr. 16, 2015 (DE) 102015105818.9

(51) Int. Cl. G06K 15/02; H04N 1/50; G06K 15/10

(52) U.S. Cl. CPC G06K 15/1836; G06K 15/1822; G06K 15/181; G06K 15/102; H04N 1/50; G06K 2215/0011

(57) ABSTRACT

In a method for visually reviewing a print data stream present in a print data language, the print data stream is rastered using a rastering device of a printing system. The rastered print data is cached in a print data memory at the printing system. A section of the cached rastered print data can be read out using a collection process executable at the printing system. The collection process can receive and execute a request to read out a specific section of the rastered print data. The readout rastered print data can be transmitted to a display device using a real time-capable communication connection. The rastered print data can be presented at the display device.

### CROSS REFERENCE TO RELATED APPLICATIONS

This patent application claims priority to German Patent Application No. 102015105818.9, filed Apr. 16, 2015, which is incorporated herein by reference in its entirety.

### BACKGROUND

The disclosure is directed to a method to visually review a print data stream present in a print data language, including print data languages such as, for example, IPDS, AFP, PCL, PS.

The foundations of rastering techniques in digital printing emerge from “Digital Printing-Technology and Printing Technics of OCÉ Digital Printing Presses”, February 2005, 9th Edition, ISBN 3-00-001081-5, Chapter 2. In digital printing, semitones often cannot be directly reproduced. They are generated by means of rastering via the ratio of printed to unprinted partial areas. In order to simulate a darker semitone, the number of printed points is increased, wherein the proportion of the white area is reduced. If the partial areas are very small, they are no longer differentiable to the human eye and only the resulting greyscale value or semitone is perceived. The type of rastering may be established by the user upon creation of a print job. There are different rastering methods, such as the dot pattern method, an amplitude-modulated raster (dithering method) and a frequency-modulated raster (error diffusion).

The print quality impression of rastered semitones is significantly determined by the raster fineness, the number of reproducible greyscales, the raster dot shape, as well as on the tone value curve, the uniformity and reproducibility, and on superstructures such as contouring and Moiré. These parameters may be influenced within certain limits via selection of a suitable rastering method and suitable rastering parameters.

There are methods and devices to implement a print preview. The data to be printed are hereby presented on a monitor optimally just as they are printed on a recording medium. This print preview is executed before the actual printing process in order to be able to detect and correct possible errors.

There are standardized printing formats (such as the PDF format) which very exactly reproduce a print image and are preferably used in connection with standardized rastering devices, such that the final print image is established very early in the overall printing process. The advantage of such a printing process is that errors and problems may be recognized early. However, it is disadvantageous that no optimization of the print image may be made at the printing system itself, and functions that are possibly present at the printing system may not be used due to the early establishment of the printing properties. Often, specific quality levels that would inherently be possible with the printing system may hereby no longer be realized.

On the other hand, there are print languages (for example IPDS, AFP, PCL, PS) which describe a print image but do not establish it in the smallest detail, wherein a plurality of print properties are only established in the printing system. For example, which rastering method that is applied may only be established in the printing system. The print data may be printed at different printing systems, wherein they are printed with corresponding adaptation to the possibilities of the respective printing systems, and the printing properties are adjusted accordingly. This is the situation that predominates in high-capacity printing. However, due to the late establishment of the printing properties, the generated print images may differ significantly, even if the incoming print data agree.

A method and a computer programming system for visual review of a print data stream that is present in a print data language arises from DE 101 23 411 A1. A print rastering process is executed at a printing system. A display rastering process that corresponds precisely to the print rastering process is executed for visual review. The rastered data of the display rastering process are presented at a monitor.

With this method it is possible to implement a precise visual review of documents that are present as a print data stream in a print data language. However, if the display rastering process does not correspond exactly to the print rastering process, significant differences of the print data may then exist in the presentation at the monitor and in the presentation on the recording medium.

In DE 101 23 411 A1, an alternative embodiment is described given which the print data are rastered at a print server, and then the rastered print data are on the one hand presented at a monitor and on the other hand are transmitted from the print server to a printing system. In this embodiment, the problems explained above are avoided by rastering the print data with two processes that are independent of one another. However, the data set of the print data multiplies upon rastering, such that—at least in high-capacity printing—it is in practice extremely difficult to transfer the large data set of print data from the print server to the printing system so quickly that the printing system may continuously print to a recording medium.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 illustrates a digital printer with an example configuration of said digital printer.

FIG. 2 illustrates a schematic block diagram, a printing system, a control system and systems connected therewith,

FIG. 3 illustrates a schematic block diagram, a main computer of a control system and client computers connected with said main computer,

FIG. 4 through FIG. 14 illustrate schematic hardware and software components of a control system or of client computers,

FIG. 15 illustrates a method to visually review a print data stream present in a print data language, in a workflow diagram, and

FIG. 16 illustrates a method to visually review a print data stream present in a print data language, in a workflow diagram.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure.

An object of the disclosure is to achieve a method and a system for visual review of a print data stream present in a print data language (e.g., IPDS, AFP, PCL, PS). The method and system allow a presentation of the print data stream at a display device and the presentation reliably conforms to the corresponding print image on a recording medium.

A method according to the disclosure for the visual review of a print data stream present in a print data language (IPDS, AFP, PCL, PS) includes the following steps:
rastering of the print data stream by means of a rastering device, and caching of the rastered print data in a print data memory at the printing system,
reading out of a section of the cached, rastered print data by means of a collection process executable at the printing system, which collection process may receive and execute a request to readout a specific section of the rastered print data,
transmission of the read-out, rastered print data to a display device using a real time-capable communication connection, and
presentation of the rastered print data at the display device.

With this method, the print data that are rastered at the printing system and present in the print data memory at the printing system (i.e., the print data used to control a print group of the printing system) are read out in sections, transmitted to the display device and presented there. Original data are thus herewith presented at the display device. The danger of an incorrect presentation at the display device is hereby significantly reduced.

The print data are read out by a collection process that can be executed at the printing system, which collection process may receive and execute a request to read out a specific section of the rastered print data. On the one hand, the readout of a predetermined segment may be triggered outside of the printing system via a corresponding request, and on the other hand it is ensured that the data processes at the printing system are not directly engaged and that these cannot be manipulated. Only a very limited engagement with the data process, with which only predetermined sections of the rastered print data may be copied and relayed, is hereby allowed.

Via the use of the real time-capable communication connection, it is ensured that the print data rastered in the printing system are transmitted to the display device and displayed there in sections before they are printed onto a recording medium at a printing system.

In an exemplary embodiment, the rastered print data cached in the print data memory is transmitted directly to a print group to control the color application onto a recording medium.

The printing system is designed for digital printing, meaning that the print group is controlled by means of digital print data. Every print sheet may hereby include an individual print image.

The printing system may comprise one or more print groups. The print group is the device of the printing system with which printing ink is applied onto a recording medium. Each print group of a printing system typically prints to the recording medium with a different print color. The print color is hereby a toner, an ink or a liquid toner. In an inkjet printing system, the print group is made up of a print head comprising print nozzles.

The rastered print data may be scaled in the printing system before the transmission to the display device. Display parameters—for example size and/or resolution—of a display region of the display device can be determined beforehand, and the scaling is executed according to the requirements of these display parameters. The data set that describes the rastered print data of the read-out section is reduced via the scaling of the rastered print data before the transmission to the display device, whereby the bandwidth required for transfer to the display device is reduced. This allows the display of larger sections of the print data at the display device in real time.

Before the readout of a section of the cached, rastered print data, this section is can be requested by the display device. Display parameters—for example size and/or resolution of a display region of the display device—may hereby be passed as well.

A second section of the cached, rastered print data that is to be printed on the back side of a recording medium may also be read out. The first read-out section is to be printed on the front side in the corresponding region of the recording medium. The two sections are superimposed before they are transmitted to the display device. The registration compliance of the printout on the front side and back side of the recording medium may be checked with these superimposed sections. The data of the back side of the recording medium is displayed mirror-inverted at the display device. To differentiate the data of the back side and the data of the front side given their joint presentation, the respective information is characterized differently (in particular with a different color) during their display. Given a superposition of the data of the front side and back side of the recording medium, the data of the back side may be additionally scaled relative to the data of the front side in order to compensate for a shrinkage of the recording medium between the printing processes of the front side and back side. This is appropriate primarily given printing processes in which the recording medium is heated in order to fix toner particles or dry ink.

Furthermore, upon readout of a section of the cached, rastered print data it is appropriate to read out respective corresponding color separations and to merge these into a color image. In an exemplary embodiment, the color image is converted into a color space that corresponds to the color space used at the display device before the transmission of the read-out, rastered print data to said display device. This color space is normally the RGB color space or sRGB color space, but are not limited hereto. A print data stream to describe print data is used primarily in digital printing, with which print data stream every page may be printed with a different print image. The cached, rastered print data are available only for a brief time before they are relayed to the printing system. The steps of the readout and transmission of the rastered print data therefore need to take place without noteworthy time delay so that a user of the control panel may promptly react upon detecting an error in the print data.

Specific sections of the print data stream are can be reviewed in the manner of a random sampling, wherein—for example—a section from every fifteenth to five-hundredth page is transmitted to the display device and presented there.

The data to be transmitted to the display device are determined via a real time-capable communication connection. Such a real time-capable communication connection can be designed according to the WebRTC standard. Real time-capable means that the latency is so low and the data transmission rate is so high that a page is transferred to the display device and displayed there without noticeable delay before it is printed out at the printing system. Since the data set for presentation of one page and the time available in order to display this page at the display device before it is printed by the printing system onto the recording medium differ significantly depending on the printing system (in particular its resolution and the print speed, the printing colors (black/white; highlight color; full color printing)) and depending on whether binary or multilevel print data are present, the requirements for the latency and data rate in order to provide a real time-capable communication are accordingly different. In practice, it has been shown that the latency should in no case be higher than 50 ms. In an exemplary embodiment, the latency is not more than 1 ms or not more than 100 μs, and in particular not more than 10 μs or not more than 5 μs. In an exemplary embodiment, the data transfer rate is at least 10 GBit/s. In an exemplary embodiment, the data rate is at least 20 GBit/s or in particular at least 25 GBit/s, or at least 30 GBit/s.

A computer (PC, tablet, mobile telephone) that has a screen at which a control panel is displayed can be used as a display device, wherein the rastered print data are presented in the control panel. In an exemplary embodiment, the control panel is presented in a browser.

The rastered print data may be compressed in the printing system before transmission to the display device. In an exemplary embodiment, a lossless data compression is used for this.

In an exemplary embodiment, the production system is a liquid toner printing system.

Liquid toner printing systems are printing systems in which toner particles are applied onto a recording medium to be printed with the aid of a liquid developer. For this, a latent charge image of a charge image carrier is inked by means of electrophoresis, with the aid of a liquid developer. The toner image that is created in such a manner is transferred onto the recording medium indirectly via a transfer element or directly. The liquid developer has toner particles and carrier fluid in a desired ratio. Mineral oil can be used as a carrier fluid. In order to provide the toner particles with an electrostatic charge, charge control substances are added to the liquid developer. Further additives are additionally added, for example in order to achieve the desired viscosity or a desired drying behavior of the liquid developer.

Such digital printers are known from DE 10 2010 015 985 A1, DE 10 2008 048 256 A1, DE 10 2009 060 334 A1 or DE 10 2012 111 791 A1, for example.

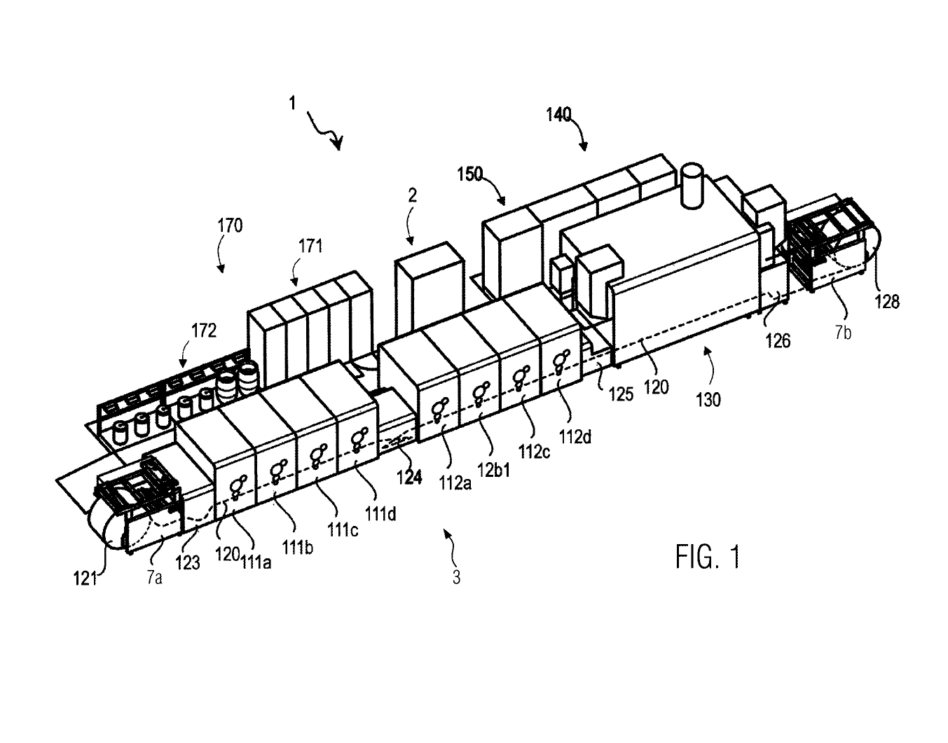

An exemplary embodiment of a digital printer comprises a printing system 1 and a control system 2 (FIG. 1).

As shown in FIG. 1, a printing system 1 that is a digital printer for printing to a recording medium 120 has one or more print groups 111a-111d and 112a-112d that print a toner image (print image) onto the recording medium 120. As shown, a web-shaped recording medium 120 (as a recording medium 120) is unrolled from a roller 121 with the aid of a take-off 7a and is supplied to the first print group 111a. The print image is fixed on the recording medium 120 in a fixer 130. The recording medium 120 may subsequently be taken up on a roller 128 with the aid of a take-up 7b. Such a configuration is also designated as a roll-to-roll printer.

In an exemplary embodiment shown in FIG. 1, the web-shaped recording medium 120 is printed in full color on the front side with four print groups 111a through 111d and on the back side with four print groups 112a through 112d (what is known as a 4/4 configuration). For this, the recording medium 120 is unwound from the roller 121 by the take-off 7a and is supplied via an optional conditioning group 123 to the first print group 111a. The recording medium 120 may be pretreated or coated with a suitable substance in the conditioning group 123. Wax or chemically equivalent substances can be used as a coating substance (also designated as a primer).

This substance may be applied over the entire area or only to the locations of the recording medium 120 that are to be printed to later, in order to prepare the recording medium 120 for printing and/or to affect the absorption property of the recording medium 120 upon application of the print image. It is therefore prevented that the toner particles or carrier fluid that are applied later do not penetrate too significantly into the recording medium 120, but rather remain essentially on the surface (color quality and image quality is thereby improved).

The recording medium 120 is subsequently initially supplied to the first print groups 111a through 111d in order, in which print groups only the front side is printed to. Each print group 111a-111d typically prints to the recording medium 120 in a different color or even with different toner material, for example MICR toner which can be read electromagnetically.

After printing to the front side, the recording medium 120 is turned in a turner 124 and supplied to the remaining print groups 112a-112d for printing to the back side. Optionally, an additional conditioning group (not shown) may be arranged in the region of the turner 124, via which conditioning group the recording medium 120 is prepared for printing to the back side, for example a quick fixing (partial fixing) or other conditioning of the previous printed front side print image (or of the entire front side or also of the entire back side). It is thus prevented that the front side print image is mechanically damaged by the subsequent print groups upon further transport.

In order to achieve a full color printing, at least four colors (and therefore at least four print groups 111, 112) are required, and in fact the primary colors YMCK (yellow, magenta, cyan and black), for example. Additional print groups 111, 112 with special colors (for example customer-specific colors or additional primary colors in order to expand the printable color space) may also be used.

Arranged after the print group 112d is a registration unit 125 via which the register marks (which are printed on the recording medium 120 independently of the print image, in particular outside of the print image) are evaluated. The transversal and longitudinal registration (the primary color dots that form a color dot should be arranged atop one another or spatially very close to one another; this is also designated as color registration or full-color registration) and the register (front side and back side must precisely spatially coincide) can therefore be adjusted so that a qualitatively good print image is achieved.

Arranged after the registration unit 125 is the fixer 130 via which the print image on the recording medium 120 is fixed. Given electrophoretic digital printing, a thermal dryer can be used as a fixer 130, which thermal dryer largely evaporates the carrier fluid so that only the toner particles still remain on the recording medium 120. This occurs under the effect of heat. The toner particles may thereby also be fused onto the recording medium 120, insofar as they have a material (resin, for example) that may be fused as the result of a fixer heat effect.

Arranged after the fixer 130 is a drawing plant 126 that draws the recording medium 120 through all print groups 111a-112d and the fixer 130 without an additional drive being arranged in this region. A friction drive for the recording medium 120 would create the risk that the as of yet unfixed print image could be smeared.

The drawing plant 126 supplies the recording medium 120 to the take-up 7b that rolls up the printed recording medium 120.

Centrally arranged in the print groups 111, 112 and the fixer 130 are all supply devices for the digital printing 1, such as climate control fixer modules 140, power supply 150, control system 2 (controller), fluid management modules 170 (such as fluid control unit 171 and reservoirs 172 of the different fluids). In particular, pure carrier fluid, highly concentrated liquid developer (higher proportion of toner particles in relation to the carrier fluid) and serum (liquid developer plus charge control substances) are required as fluids in order to supply the digital printer 1, as well as waste containers for the fluids to be disposed of or containers for cleaning fluid.

The digital printer 1, with its structurally identical print groups 111, 112, is of modular design. The print groups 111, 112 do not differ mechanically, but rather only due to the liquid developer (toner color or toner type) that is used therein.

Such a print group 111, 112 is based on the electrophotographic principle, in which a photoelectric image carrier is inked with charged toner particles with the aid of a liquid developer, and the image that is created in such a manner is transferred to the recording medium 120.

The print group 111, 112 is essentially comprised of an electrophotography station, a developer station and a transfer station.

Depending on the model and configuration, such high-capacity digital printers extend over a length of 10 m to 30 m. Therefore, multiple control panels are to be appropriately provided that simultaneously allow multiple people to read data of the digital printer and look at control panels at multiple locations.

The printing system 1 comprises the control system 2 and the print group unit 3. The control system 2 is designed to prepare print jobs such that they may be printed by the print group unit 3. In an exemplary embodiment, the control system 2 includes processor circuitry configured to perform one or more functions of the control system 2. The print jobs (which are present in a print data language) hereby need to be converted into rastered data. This is normally executed in multiple intermediate steps that, among other things, include the rastering of the print data.

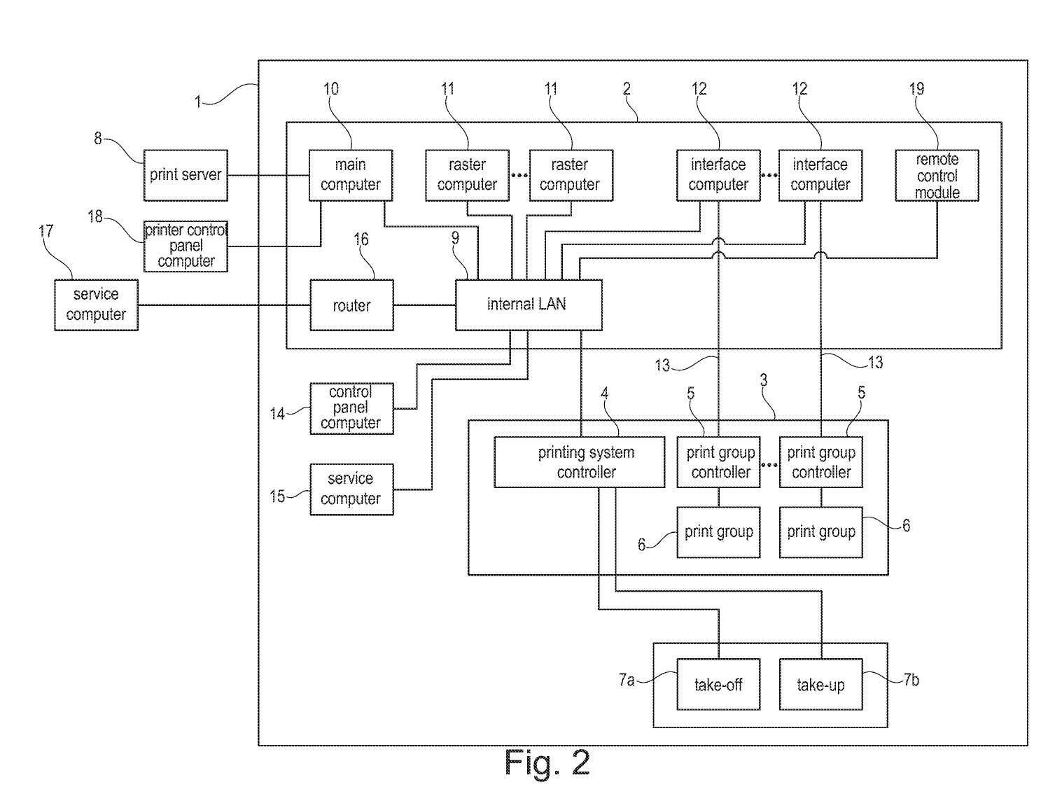

The print group unit 3 has internal control systems that comprise a printing system controller 4 and multiple print group controllers 5 (BDB: bar driving board) (FIG. 2). The print group controllers 5 transmit the rastered print data to the corresponding print groups 6. These rastered print data are either binary or multilevel print data. Given binary print data, each bit represents a print point. If the bit is set, the corresponding print point is printed. If the bit is not set, the corresponding print point is not printed. Given multilevel print data, a data word comprised of multiple bits is associated with each print dot; how large the respective print dot is to be printed is defined with said data word. In an exemplary embodiment, the printing system controller 4 includes processor circuitry configured to perform one or more functions of the printing system controller 4. In an exemplary embodiment, the print group controllers 5 include processor circuitry configured to perform one or more functions of the print group controllers 5.

The printing system controller 4 controls the main module of the print group unit 3, the paper transport, and executes general control tasks with regard to the print groups 6. The printing system controller 4 has interfaces with pre- and post-processing systems, which in particular comprise the take-off 7a and the take-up driver 7b. Additional pre- and post-processing systems may be connected, for example a cutting system, enveloping system or the like.

The control system 2 serves to process print jobs which are transmitted to said control system 2 from a print server 8. Such a print job normally comprises print data and a job ticket. The print data are present in a print data language (for example IPDS, AFP, PCL, PS) and are transmitted as a print data stream to the control system 2 of the printing system 1. The job ticket includes instructions as to how the print data are to be processed. The control system 2 has multiple computer units that are connected with one another via an internal LAN 9. For example, the LAN may be designed as an Ethernet or Infiniband. The computer units comprise a main computer 10, multiple raster computers 11 and multiple interface computers 12.

The main computer 10 receives the print jobs and distributes portions of the print jobs to the raster computers 11 for rastering of the print data. The main computer 10 hereby attempts to utilize the raster computers 11 as uniformly as possible.

The raster computers 11 convert the print data into the rastered print data suitable for controlling the print groups 6. The rastered print data are forwarded from the raster computers 11 to the interface computer 12 via the internal LAN 9.

The rastered print data are cached at the interface computers 12. Each interface computer 12 is respectively connected with one of the print group controllers 5 and transfers the rastered print data to the corresponding print group controller 5 via the optical waveguide 13 for printout of a specific color. The print data are thus present at the interface computers 12 in the form of color separations of the respective print group 6.

The printing system controller 4 is connected to an external interface of the internal LAN 9 of the control system 2 and receives from control commands from the main computer 10 of the control system 2 for controlling the printing system and the pre- and post-processing system.

The internal LAN 9 of the control system 2 may have additional external interfaces for the connection of one or more control panel computers 14 and/or one or more service computers 15.

Furthermore, the control system 2 has a router 16 to which a service computer 17 may be connected via a WAN.

A printer control panel computer 18 is directly connected with the main computer 10 of the control system 2 via an SPO-LAN (Service Panel Operator-LAN). The printer control panel computer 18 serves to monitor and control the print data. This printer control panel computer 18 is typically used by an operator who controls the workflow of the different printing processes at the printing system. Conversely, the control panel computer 14 or service computer 15 are used by operators or service technicians who are responsible for the continuous operation of the printing system.

The printing system may have multiple control panel computers 14 and/or multiple service computers 15, and also may be connected with multiple printer control panel computers 18.

The service computers 15, 17 differ from the control panel computers 14 in their access rights, wherein the service computers 15, 17 may make more adjustments to printing systems than the control panel computer 14, as is explained further below. For example, an installation of software components may also be performed at service computers or at a printing system, which is not possible at control panel computers 14.

The control system 2 has a remote control module (PCI: Power Control Interface) 19. With this remote control module 19, the control system 2 may be started up or shut down via remote control. Moreover, this remote control module 19 supplies additional functions for remote control of the control system 2.

Given this printing system, multiple control panels are provided at the computers 14, 15, 17, 18.

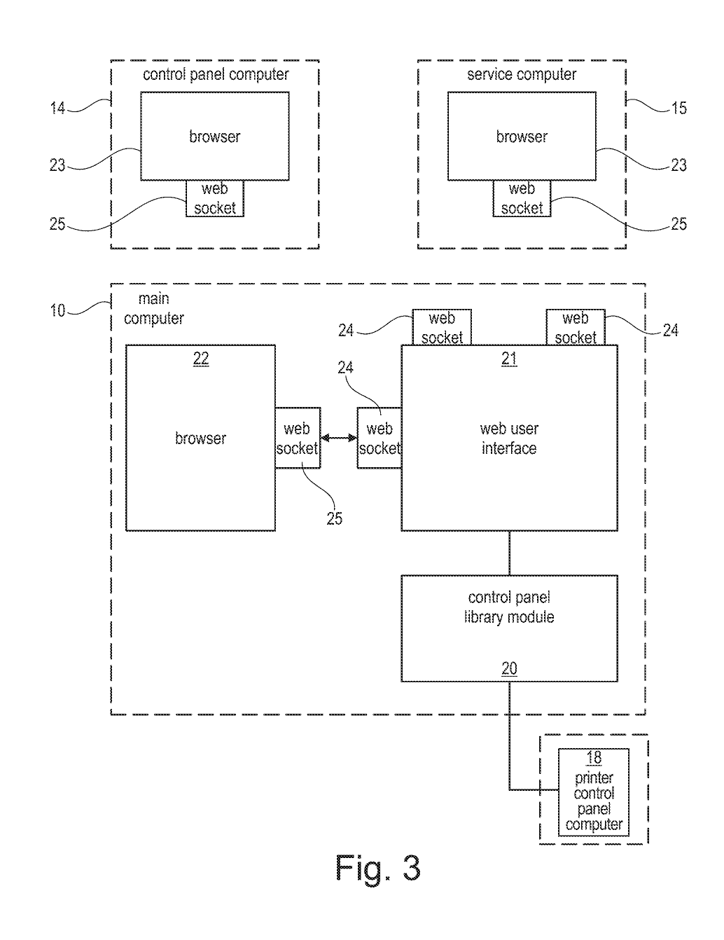

At the main computer 10 of the control system 2, a control panel library module 20 is provided which comprises multiple control panel modules with which a control panel for the printing system may be presented on the computer display (FIG. 3). The control panel modules also allow a control of the printing system 1 via the control panel presented on the computer display.

The printer control panel computer 18 is connected with the control panel library module 20 via the SPO-LAN. Provided at the printer control panel computer 18 is a client program with which the control panel is presented and the corresponding control functions are executed.

The control panel library module 20 is connected with a web user interface 21 that is a web server with which the control panel modules of the control panel library module 20 are made available in a browser. In the present exemplary embodiment, the web user interface 21 has been realized via an Apache Tomcat server. In principle, other web servers are also suitable here.

This web user interface 21 may communicate directly with a browser 22 provided on the same computer, wherein the communication is implemented via web sockets 24, 25. For communication with “external” browsers 23 which are provided on additional computers 14, 15, the web user interface 21 is coupled with an additional respective web socket 24. The web socket 24, 25 is a software module that forms an interface which may establish a continuous logical Internet connection with a browser that is connected via a data connection with the computer at which the web socket 24, 25 is arranged. The data connection is hereby a data network, for example.

The browser 22 on the main computer 10 and the browsers 23 on the computers 14, 15 may thus be continuously supplied with information from the web user interface 21 or may transmit information and in particular messages to the web user interface 21. For this, the browsers 22, 23 respectively have a corresponding web socket 25.

The individual software modules that are provided on the different computers are explained in detail in the following.

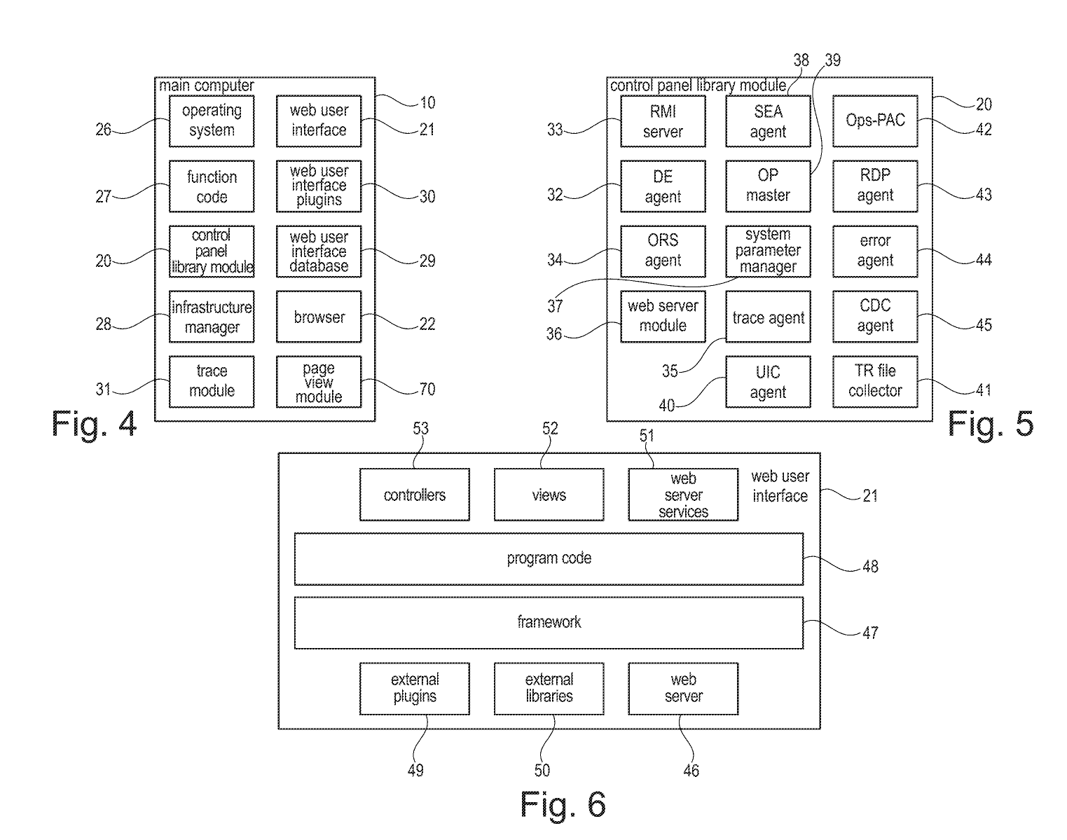

In addition to the already explained control panel library module 20, the web user interface 21 and the browser 22, an operating system 26, a function code 27, an infrastructure manager 28 for interfaces to the hardware, a web user interface database 29, web user interface plugins 30, a trace module 31 and a page view module 70 are provided at the main computer 10 (FIG. 4).

The trace module 31 serves to record error protocols of all software components executed in the control system 2 and/or in the print group unit 3, and/or of “external” software components that are executed on other computers 8, 14, 15, 16, 17, 18.

The function code 27 is designed for the execution primarily of printing-relevant software routines, for example a load distribution of the print data from the main computer 10 to the raster computers 11, raster calculations at the raster computers 11 for a rastering of the print data, controlling a caching of the rastered print data at the interface computers 12, and controlling a display of the rastered print data at a control panel. With the function code 27, the arriving print jobs are processed so that they may be printed out at the print group unit 3.

Upon receipt of a print job, the function code 27 caches the job ticket at the main computer 10, and upon distribution of the print job to the raster computers 11 the function code 27 caches at the main computer 10 association information about the association of the raster computers 11 with the sections of the respective print job that are to be rastered.

Upon distribution of the rastered print data for printing to the interface computers 12, the function code 27 also stores distribution information about the rastered print data cached at the respective interface computer 12.

The page view module 70 serves to implement a method for visually reviewing a print data stream present in a print data language, as is explained further below.

The web user interface database 29 includes all persistent data for the operation of the web user interface 21, for example long-term data, data for user configuration, settings, initialization data (for sensors, for example), data for monitoring structures (which are explained further below), as well as additional data that are necessary for the operation of the web user interface 21.

The web user interface plugins 30 serve for communication with the local computer or additional external computers at which corresponding web user interface plugs are provided. Predefined tasks or applications are stored in a web user interface plugin 30.

The control panel library module 20 comprises a plurality of control panel modules that are explained in detail in the following (FIG. 5):

A DE agent (device agent) 32 creates a data connection for the communication between the control panel and the printing system, and represents the link between the control panel and the printing system. Furthermore, the DE agent 32 provides a standardized interface in order to make the printer status available.

An RMI server (Remote Method Invocation server) 33 has functions that may be called by an external computer and that are executed on the computer at which the RMI server is executed, for example for the further processing of events. Furthermore, it provides functions that facilitate or enable such a remote access.

An ORS agent (OCÉ Remote Service agent) 34 collects hardware data and data of software events and transfers these data from the main computer 10 to a computer (not shown) of a service center via a WAN (Wide Area Network).

A trace agent 35 enables the recording or logging of trace data of other modules and the preparation of these data.

A web server 36 enables the downloading of program libraries (for example of Java program libraries) from the main computer 10 to the computer 14 in order to be able to present and control the control panel at this computer 14. Furthermore, the web server 36 provides a web start function (for example a Java web start function) in order to initialize the control panel at the computer 14. In the present exemplary embodiment, the web server 36 is realized by an Apache Tomcat server. In principle, any other web server, any other program library and/or any other web start function is suitable for this.

A system parameter manager 37 (SPManager) serves for data distribution between the modules.

An SEA agent (service event log agent) 38 creates a protocol or a log file of the events that have occurred.

An OP master 39 provides a network interface, for example an SNMP gateway for the transfer of parameters to and from the printing system 1.

A UIC agent (User Interface Controller agent) 40 enables the control of predetermined workflows or the adjustment of defined states of printing systems connected with the main computer 10. For example, the startup of the printing system 1 may be executed automatically with this.

A TR file collector 41 is an agent that—as a supplement to the trace agent 35—collects and prepares trace data from programs executed on the main computer, which programs have been provided by third-party vendors.

An Ops-PAC (Ops Privileged Access Service) 42 serves to assign privileged rights (administrator rights) to other agents or applications for the implementation of specific functions. These privileged rights are predominantly necessary in order to execute the agents or applications with the desired effect.

An RDP agent (Remote Diagnosis Process agent) 43 provides an internal service interface.

An error agent 44 serves to remedy, collect, distribute, present and reset errors.

A CDC agent 45 serves for the normalized relaying of printing parameters to other agents or modules to other control systems 2 of other printing systems 1. These printing parameters are, for example, paper width, color etc.

The web user interface 21 comprises a plurality of web user interface modules that are explained in detail in the following (FIG. 5):

A web server module 46 (for example an Apache Tomcat) provides the web server functions (already explained above) of the web user interface 21. The web server module 46 and the web server 36 explained above may also be combined into one web server that is executable or executed on the main computer 10.

In the web server 46 is a framework 47 that provides rules, methods, functions, classes and/or structures for the control of the web server module 46, in particular with regard to data objects with which a control panel is described. In the present exemplary embodiment, the framework 47 is a Grails framework. In principle, other frameworks are also suitable here.

The programming of the control of the web server module 46 or of the web user interface 21 takes place with the aid of a program code 48. Program routines that are part of the program code 48 are further transmitted as needed to the browsers 22, 23 for execution, wherein the browsers 22, 23 are controlled via these transmitted program routines. In an exemplary embodiment, the browsers 22, 23 are controlled in a control panel file, as is explained further below. The program code 48 is created in one or more (scripting) programming languages. In the present exemplary embodiment, the (scripting) programming languages that are used are Java and Groovy. In principle, other programming languages or scripting programming languages are suitable here. The program code 48 includes printer-specific programs, program routines, methods, functions, classes, structures and/or extensions.

External plugins 49 and external libraries 50 are used in order to provide additional functions for the programming and/or control of the web user interface 21.

Web server services 51 are made available by the web user interface 21 to external communication partners, wherein external communication partners are systems, installations, devices or software modules that are located outside of the web user interface and communicate with said web user interface 21. The web server services 51 are initiated by the external communication partners and execute functions within the web user interface 21.

Data are processed with the aid of views 52 for presentation at the user interface of the control panel.

Control structures 53 (controllers) take over control functions within the web user interface 21, prepare the data to be presented in terms of their content, provide functions and data, wherein in particular data to be displayed at the request of the browsers 22, 23 are provided to the views 52.

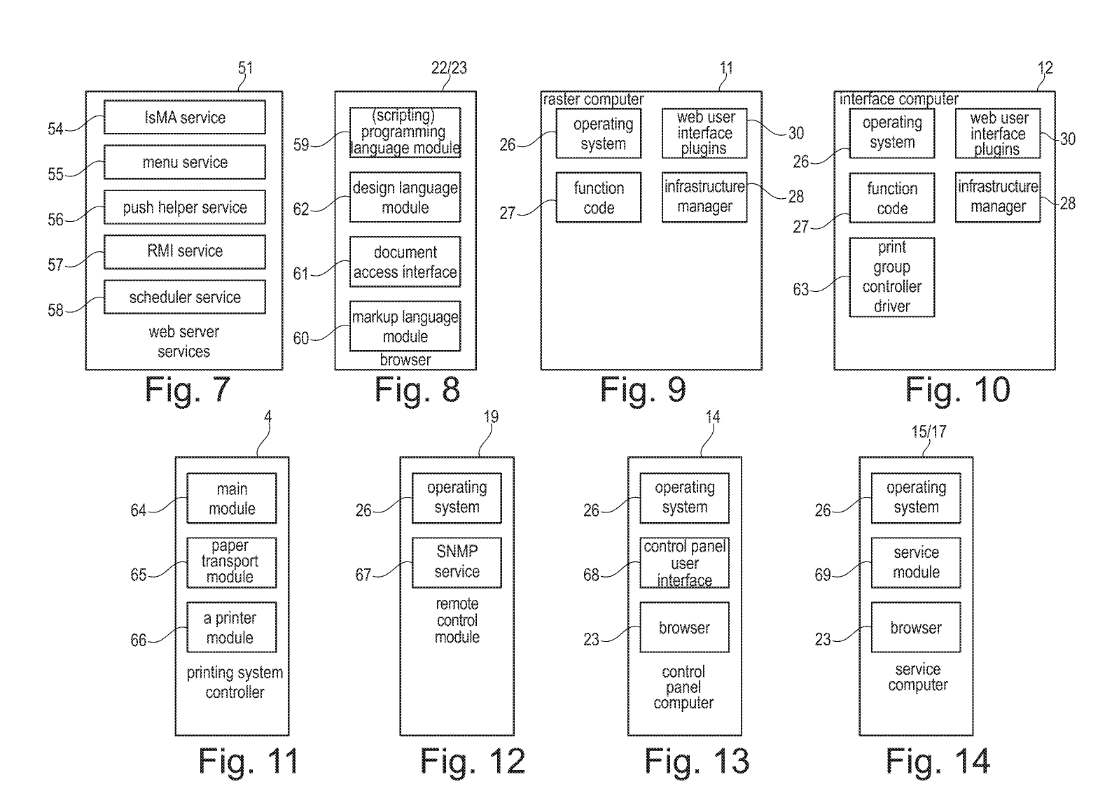

The web server services 51 include a plurality of service components that are explained in the following (FIG. 7).

An IsMa service (infrastructure manager service) 54 serves to be able to call plugins and communicate with other IsMa services 28 at “external” systems, for example at other computers 11, 12.

Menu structures are generated and administered via a menu service 55. Menus may be dynamically reloaded at “external” systems, for example.

A push helper service 56 enables a load distribution and monitored, chronologically staggered transfer of data to “external” systems.

An RMI service 57 enables the communication between the web user interface 21 and the RMI server 33 of the control panel library module 20.

A scheduler service 58 reacts to software events and fulfills chronologically pre-planned tasks, for example a purging of a database.

The browsers 22, 23 include various browser components that are explained in the following (FIG. 8).

A (scripting) programming language module 29 serves to control the browsers 22, 23 and to control their communication with the web user interface 21. The (scripting) programming language module 59 is an interpreter or a compiler for a scripting programming language or a programming language. In the present exemplary embodiment, JavaScript is used as a scripting programming language. In principle, other (scripting) programming languages are also suitable here.

A markup language module 60 enables the interpretation and presentation of the markup language files transmitted to the browsers 22, 23, wherein the markup language serves for the structuring of digital contents (such as texts, images and hyperlinks) in electronic documents, as has already been explained above. In the present exemplary embodiment, the markup language is realized according to the “HTML5” (Hypertext Markup Language) standard, which is presently developed by the World Wide Web Consortium. In principle, other markup languages are also suitable here.

A document access interface 61 is an interface that enables access to structured electronic documents [such] as the markup language files transmitted to the browsers 22, 23. Their data structure may hereby be presented in the form of a tree structure. In the present exemplary embodiment, a document access interface according to the “DOM Level 3” (Document Object Model) standard is used, which standard has been defined by the World Wide Web Consortium. In principle, other document access interfaces are also suitable here.

A design language module 62 provides a text-based design language for the formatting or declarative programming language for style templates of the structured electronic documents. The presentation of the markup language files transmitted to the browsers 22, 23 is formatted with the aid of the design language module 62. In the present exemplary embodiment, the design language is realized according to the “CSS3” (Cascading Style Sheets) standard, which has been defined by the World Wide Web Consortium. In principle, other design languages are also suitable here.

The raster computers 11 respectively comprise various software components (FIG. 9). In the present exemplary embodiment, these software components are an operating system 26, the function code 27, the infrastructure manager 28 and web user interface plugins 30, which have already been explained above.

The interface computers 12 respectively comprise various software components (FIG. 10). In the present exemplary embodiment, these software components are an operating system 26, the function code 27, the infrastructure manager 28 and web user interface plugins 30, which have already been explained above. In addition to these software components, another print group control driver 63 is present that enables the interface computer 12 to transmit print data to the print group controller 5. The print group control drivers 63 moreover provide information about the toner color printed at the respective interface computer 12 to the page view module 70 and the function code 27 of the main computer 10.

The printing system controller 4 includes various software components (FIG. 11) that are explained in the following. In an exemplary embodiment, the various software components, when executed by processor circuitry of the print system controller 4, control the print system controller 4 to perform the corresponding functions of the printing system controller 4.

A main module 64 serves to control and monitor additional software components of the printing system controller 4.

A paper transport module 65 controls the paper transport of the printing system 1 in that it controls the take-off 7a, the take-up 7b and additional drive rollers (not shown) in the print group unit 3.

Via sensors (not shown), a print group unit module 66 detects various parameters of the print group unit 3 (for example temperature, humidity, presence of paper etc.) that directly or indirectly affect the printing capability and/or the print quality. From the detected sensor data, the print group unit module 66 determines a printer status in that it evaluates the detected parameters. This evaluation occurs via a check as to whether the respective parameter values are within predetermined value ranges that define a regular operation of the print group unit 3. The printer status is transmitted to the main computer 10.

As software components, the remote control module 19 includes an operating system 26 and an SNMP (Simple Network Management Protocol) service 67 (FIG. 12). The SNMP service 67 serves for simple network communication of the remote control module 19 with other devices of the control system 2.

As software modules, the control panel computer 14 includes an operating system 26, a browser 23 and a control panel user interface 68 (FIG. 13). The control panel user interface 68 enables control panels for the operation of the control system 2 and/or of the print group unit 3 to be displayed at the control panel computer 14, and enables adjustments to be made in these control panels. The control panel user interface 68 is initialized, presented and controlled with the aid of the Java program libraries and the Java Web Start function (downloaded from the web server 36 onto the control panel computer 14), as has already been explained above.

The service computer 15, 17 includes as software components an operating system 26, a browser 23 and a service module (CoDi: Configuration and Diagnostics) 69 (FIG. 14). With the aid of the service module 69, the configuration of the control system 2 and/or of the print group unit 3 may be changed and information regarding the software diagnosis and/or hardware diagnosis may be received from the control system 2 or the print group unit 3.

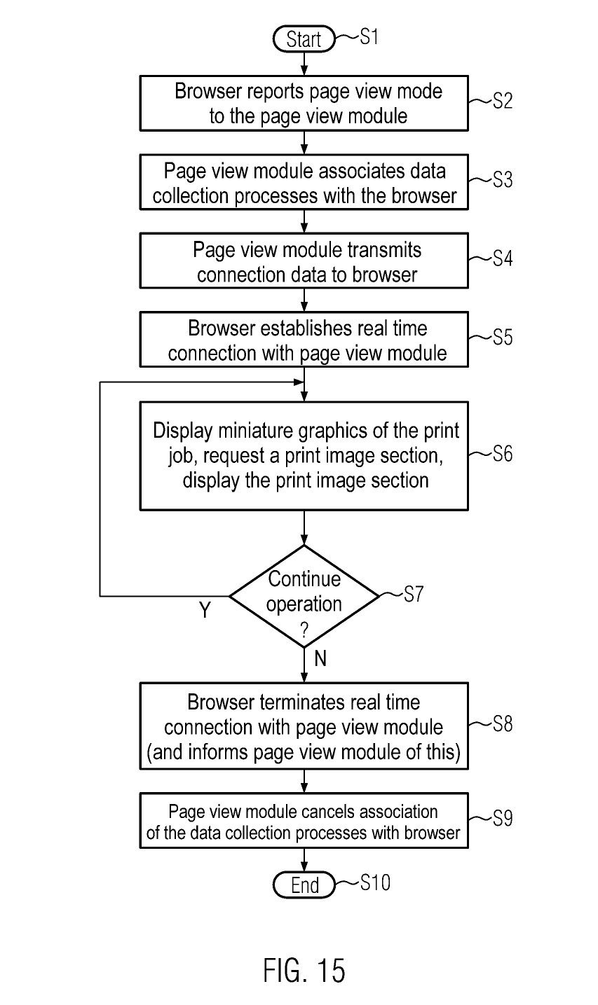

An exemplary embodiment of a method for visually reviewing a print data stream present in a print data language is explained in the following (FIG. 15).

The method begins in step S1. In step S2, a user calls the page view mode in a browser 23 in a control panel, in that said user selects the page view mode via the menu presented in the control panel. In page view mode, print jobs that have recently been implemented at the printing system 1, that are being implemented at the printing system 1 or that should be implemented at the printing system 1 in the future may be selected for visual review. The browser 23 transmits to the web user interface 21 its resolution (set at the presented control panel) and the size and number of display regions serving for the display of miniature graphics of print jobs.

Executed after this is step S3, in which the page view module 70 associates data collection processes with the browser 23 that has reported the page view mode. The data collection processes are processes that are executed at the interface computers 12. The data collection processes are generated by the function code 27 at the respective interface computer 12 upon starting it, and the program code of the data collection processes is a component of the function code 27. The function code 27 generates at every interface computer 12 a predetermined number of data collection processes upon the startup process of the respective interface computer 12. After their generation, the data collection processes register with the page view module 70 of the main computer 10 and transmit their connection data upon this registration.

This is then followed by the execution of step S4, in which the page view module 70 provides connection data for a real time connection with the browser 23 and transmits said data to said browser 23.

Following this, step S5 is executed, in which the browser 23 establishes—with the transmitted connection data—a real time connection with the page view module 70. The real time connection is hereby a real time-capable communication connection that is designed according to the WebRTC standard. However, the real time connection may also be designed according to any other standard for a real time communication. The real time connection exhibits a low latency due to less protocol overhead and a high data transfer rate.

The method workflow is the continued with the execution of step S6, in which the browser 23 initially displays miniature graphics of print jobs and—after a per-section selection by a user from the miniature graphics—requests the selected print image section from the page view module 70. The print image section is a section of a color separation or a section of multiple color separations of a print job that are merged into one print image, wherein a print image section may also include an entire page or an entire sheet of a print image. The merging of multiple color separations into a color image may occur in the page view module 70. The browser 23 requests a print image section from the page view module 70, receives this and displays this. Step S6 is explained in further detail below.

The method workflow is then continued with the execution of step S7, in which a check is made as to whether the operation is to be continued. If the operation is to be continued, then step S6 is executed again. If the operation is not to be continued, then the method workflow transitions to step S8. Whether the operation is to be continued may, for example, be checked if the user at the browser 23 leaves the page view mode.

The execution of step S8 then follows, in which the browser 23 terminates the real time connection with the page view module 70. In an exemplary embodiment, since the real time connection is designed as a continuous data connection, the page view module 70 is informed that the browser 23 has terminated the real time connection. Alternatively, the browser 23 may send the page view module 70 a message in which it informs the page view module 70 that the real time connection is terminated.

The execution of step S9 then follows, in which the page view module 70 cancels the association of the data collection processes with the browser 23, meaning that the page view module 70 releases the data collection processes again for a new association with one of the browsers 23.

The execution of step S10 then follows, in which the method ends.

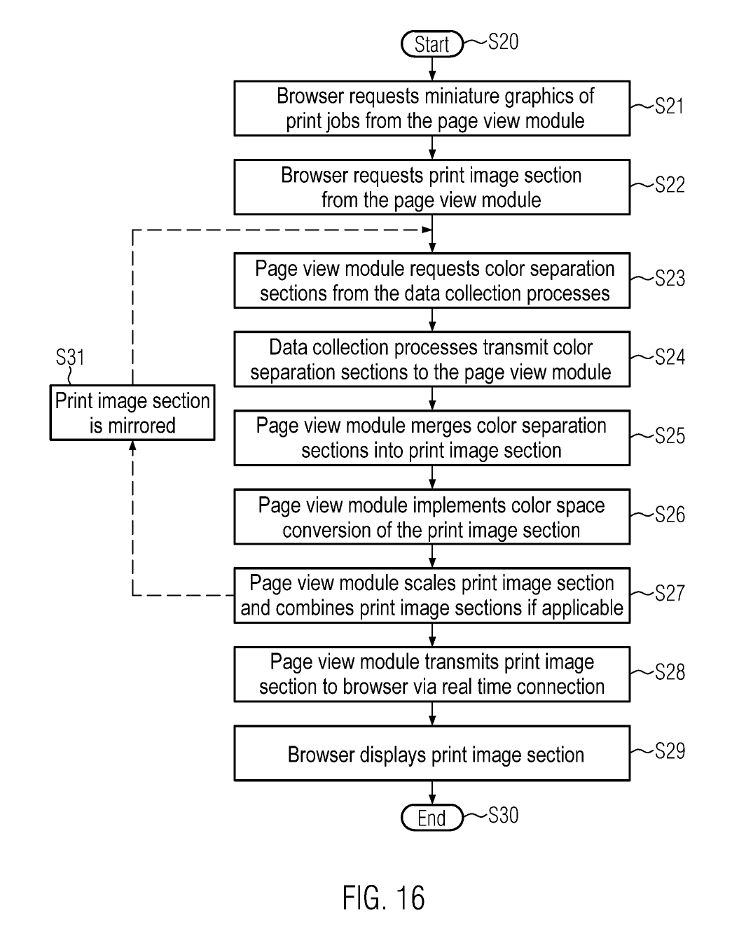

The individual sub-steps of step S6 (explained above) are explained in more detail in the following (FIG. 16).

The method begins in step S20. In step S21, the browser 23 requests miniature graphics of print jobs from the page view module 70. The miniature graphics are generated in that the page view module 70 requests corresponding sections of the color separations of print jobs from the data collection processes of the interface computers 12 (said data collection processes being associated with the browser 23), merges said color separations, reduces or scales them (in terms of their resolution) to the resolution present at the browser (which was transmitted in step S2), performs a color space conversion, and transmits them via the real time communication connection to the browser 23 for presentation, together with an identification designator for the respective print job. Sections from the print jobs listed as miniature graphics may be selected for display, wherein individual color separations, multiple merged color separations or all color separations merged into a print image can be presented. The color separations are hereby the rastered print data for a specific print color of one of the print groups 6, which rastered print data are present in the interface components 12.

The scaling of the print image section thereby takes place such that the print image section to be displayed as a miniature graphic corresponds in its display parameters (number of image points in width×number of image points in height or, respectively, resolution and/or size) to the values that were reported by the browser 23 to the page view module 70 in step S2.

In the printing system 1, the print data of the print images or print image sections are present in a CMYK color space (CMYK=Cyan Magenta Yellow Key), whereas the control panel computers 14 have display devices that are designed for an operation in an sRGB color space (sRGB=standard Red Green Blue). This has the consequence that the color space that is present for printing (CMYK) is to be converted into the color space present at the display device (sRGB) for the display of the print image section.

This is then followed by the execution of step S22, in which the operator at the browser 23 requests a print image section from the displayed miniature graphics in the page view module 70. For this, the browser 23 transmits an identification designator for the print job, the coordinate values with which the print image section to be displayed is established, as well as a color separation information with which it is established which of the color separations of the print image section (i.e. which color separation sections) are to be displayed in merged form. In an exemplary embodiment, for the display of the print image section, the browser 23 switches over into a presentation with which the print image section is displayed larger than the previous miniature graphics. For this, the browser 23 may transmit to the page view module 70 the size or resolution of the region that is provided for the display of the print image section.

Step S23 is then executed, in which the page view module 70 determines—from the information passed by the browser 23—which color separation sections are to be requested from the corresponding data collection processes, and requests these. For this, the page view module 70 sends the coordinates of the section for a color separation section to be displayed to the corresponding data collection processes.

Each of the data collection processes that has received a request from the page view module 70 subsequently accesses (step S24) a print data memory (not shown) of the respective interface computer 12 in order to read out the requested section of the rastered print data that are present there. These print data represent the requested color separation section, and these data are transferred to the page view module 70.

The page view module 70 receives (step S25) the color separation sections of the individual data collection processes and combines these into the requested print image section.

The page view module implements a color space conversion of the print image section (step S26), as has already been explained above.

Step S27 is subsequently executed, in which the page view module 70 scales the print image section according to a scaling factor. The scaling of the print image section thereby takes place such that the print image section to be displayed corresponds in terms of its display parameters (number of image points in width×number of image points in height or, respectively, resolution and/or size) to the values that were reported by the browser 23 to the page view module 70 in step S22. It should thereby be enabled that a presentation that is optimally efficient and true to the original is provided in the available region of the control panel. If the size of the display region that is present at the control panel corresponds to the size of the print image section that is to be displayed, no scaling is implemented, meaning that the scaling factor amounts to 1. The scaling may also optionally be deactivated in order to provide the print image section in the original size or original resolution.

The method workflow is subsequently continued with the execution of step S28, in which the page view module 70 transmits the print image section generated from the color separation sections to the browser 23 via the real time connection. The data to be transferred are hereby transferred to the browser efficiently 23 and with only low latency.

The execution of step S29 then follows, in which the browser 23 displays the print image section in the display region.

The method ends in step S29.

Print images (or their color separations) that are requested at a browser 23 via the real time communication interface can be transferred efficiently and quickly from the page view module 70 at the main computer 10 to one of the browsers 23 with the method presented in FIG. 15 for the visual review of a print data stream present in a print data language, and with the partial method shown in FIG. 16 for the visual review of a print data stream present in a print data language. In this example, the print data to be displayed are efficiently extracted from the print data present at the interface computers 12 for the respective color separation. The display at the control panel of one of the browsers 23 are sectioned, scaled and color converted for the display at the control panel. The data transfer thereby occurs efficiently, quickly and without higher latencies via the real time communication.

With the methods or partial methods explained above, print images or print image sections are displayed at a control panel for the visual review of a print data stream present in a print data language, wherein the displayed print image sections correspond to the raster data to be printed. For this, the raster data rastered by the raster computers 11—which raster data are transferred to the print groups 6 via the interface computers 12—are copied by the data collection processes. In the method explained above, the data collection processes are arranged at the interface computers 12. However, they may also be arranged at the raster computers 11 and read out the raster data present there. The data collection processes thus create a copy of the raster data to be printed, which raster data are generated by the raster computers 11 and are printed by the print groups 6 onto a recording medium. The data collection processes thus relay the data (which is identical to the raster data to be printed) to the page view module 70 for the display of the respective print image section. The print image sections shown at the control panel are thereby based on the raster data to be relayed to the print groups 6. A monitoring of the original print data that are printed by the respective print group that are printed out by the respective print group 6 is thereby monitored, wherein this monitoring may extend to the level of individual print dots.

An additional advantage of the methods or partial methods explained above for the visual review of a print data stream present in a print data language is that, upon execution of the method for the printing and monitoring of the print image, only one raster unit (which comprises one or more raster computers 11) must be present at the printing system 1, since this raster unit generates both the print data to be printed and the print data to be generated.

In the present exemplary embodiment, caches (cache memory) are located at the raster computers 11 and/or interface computers 12, in which caches the rastered color separations are normally cached for a few minutes. These caches have a storage capacity of one to a few 10s or 100s of GB, for example. They are designed as hard drives, and in particular as semiconductor hard drives (SSDs).

The page view module 70 may additionally determine and display a registration accuracy or register compliance. This is indicated by the dashed arrow in FIG. 16. For this, after execution of the step S27 (in which a possible shrinkage of the recording medium due to the printing process was taken into account in the scaling of the print image section) the page view module 70 executes step S31, in which the print image section that reproduces the front side to be printed is mirrored. Such a mirroring may take place via the selection of suitable indices with which the data of the print image section is accessed.

After execution of step S31, step S23 is executed again, wherein this and the following steps are implemented for a print image section that reproduces the back side to be printed.

Given execution of step S27 for the print image section that reproduces the back side to be printed, this print image section is initially scaled and is then combined with the print image section that reproduces the front side to be printed such that both are superimposed, such that front side and back side can be displayed simultaneously and thus their registration accuracy or register compliance may be visually reviewed.

For the implementation of a review of the registration accuracy or register compliance, steps S26 and S27 may optionally be swapped so that the color space conversion in step S26 only takes place after the combination (explained above) of the print image sections that reproduce the front side or back side to be printed. The color space conversion for the combined print image sections is thereby only implemented once, and the method is thus implemented more efficiently.

For all transmissions—in particular for the transmission via the real time communication connection—the data to be transferred may additionally be compressed in order to then be decompressed again upon receipt. In an exemplary embodiment, a lossless data compression is used.

### CONCLUSION

The aforementioned description of the specific embodiments will so fully reveal the general nature of the disclosure that others can, by applying knowledge within the skill of the art, readily modify and/or adapt for various applications such specific embodiments, without undue experimentation, and without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments. Therefore, the specification is not meant to limit the disclosure. Rather, the scope of the disclosure is defined only in accordance with the following claims and their equivalents.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer.

For the purposes of this discussion, processor circuitry can include one or more circuits, one or more processors, logic, or a combination thereof. For example, a circuit can include an analog circuit, a digital circuit, state machine logic, other structural electronic hardware, or a combination thereof. A processor can include a microprocessor, a digital signal processor (DSP), or other hardware processor. In one or more exemplary embodiments, the processor can include a memory, and the processor can be “hard-coded” with instructions to perform corresponding function(s) according to embodiments described herein. In these examples, the hard-coded instructions can be stored on the memory. Alternatively or additionally, the processor can access an internal and/or external memory to retrieve instructions stored in the internal and/or external memory, which when executed by the processor, perform the corresponding function(s) associated with the processor, and/or one or more functions and/or operations related to the operation of a component having the processor included therein.

In one or more of the exemplary embodiments described herein, the memory can be any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

### REFERENCE LIST

1 printing system
2 control system
3 print group unit
4 printing system controller
5 print group controller
6 print group
7a take-off
7 take-up
8 print server
9 internal LAN
10 main computer
11 raster computer
12 interface computer
13 optical waveguide
14 control panel computer
15 service computer
16 router
17 service computer
18 printer control panel computer
19 remote control module
20 control panel library module
21 web user interface
22 browser
23 browser
24 web socket
25 web socket
26 operating system
27 function code
28 infrastructure manager
29 web user interface database
30 web user interface plugins
31 trace module
32 DE agent
33 RMI server
34 ORS agent
35 trace agent
36 web server module
37 system parameter manager
38 SEA agent
39 OP master
40 UIC agent
41 TR file collector
42 Ops-PAC
43 RDP agent
44 error agent
45 CDC agent
46 web server
47 framework
48 program code
49 external plugins
50 external libraries
51 web server services
52 views
53 controllers
54 IsMa service
55 menu service
56 push helper service
57 RMI service
58 scheduler service
59 (scripting) programming language module
60 markup language module
61 document access interface
62 design language module
63 print group control driver
64 main module
65 paper transport module
66 a printer module
67 SNMP service
68 control panel user interface
69 service module
70 page view module
111, 111a-111d print group (front side)
112, 112a-112d print groups (back side)
120 recording medium
121 roll (input)
123 conditioning group
124 turner
125 register
126 drawing plant
128 roll (output)
130 fixer
140 climate control fixer module
150 power supply
170 fluid management
171 fluid control
172 reservoir

What is claimed is:

1. A method for visually reviewing a print data stream present in a print data language, comprising:
rastering of the print data stream using a rastering device of a printing system, and caching of the rastered print data in a print data memory at the printing system;
reading out a section of the cached rastered print data using a collection process executable at the printing system, wherein the collection process receives and executes a request to read out a specific section of the rastered print data;
transmitting the readout rastered print data to a display device using a real time-capable communication connection; and
presenting the rastered print data at the display device.

2. The method according to claim 1, wherein the rastered cached print data is supplied directly to a print group from the print data memory.

3. The method according to claim 1, wherein the rastered print data are scaled in the printing system before transmission to the display device, wherein display parameters of a display region of the display device are determined beforehand and the scaling is executed according to the display parameters.

4. The method according to claim 3, wherein the display parameters comprise at least one of a size and a resolution of the display region.

5. The method according to claim 1, wherein, before the reading out of the section of the cached rastered print data, the section of the cached rastered print data is requested by the display device, wherein display parameters of a display region of the display device are also transmitted.

6. The method according claim 1, further comprising:
reading out a second section of the cached rastered print data, wherein the second section is to be printed on a back side of a recording medium, wherein the first read-out section is to be printed on a front side in a corresponding region of the recording medium; and
superimposing the first and the second sections before they are transmitted to the display device.

7. The method according to claim 1, wherein a section from multiple cached color separations is read out, and the corresponding sections of the cached color separations are merged into a color image.

8. The method according to claim 6, wherein the color image is converted into a color space that corresponds to a color space used in the display device.

9. The method according to claim 1, wherein the real time-capable communication is designed according to the WebRTC standard.

10. The method according to claim 1, wherein the data transmitted to the display device is displayed in a control panel at the display device.

11. The method according to claim 10, wherein the control panel is presented in a browser.

12. The method according to claim 1, wherein the rastered print data are compressed in a printing application before the transmission to the display device, wherein the data compression is a lossless data compression.

13. The method according to claim 1, wherein:
a function code generates a control process at a main computer;
the control process subdivides the print data stream into individual segments;
the raster device comprises multiple raster computers,
the control process distributes the individual segments to the different raster computers and the individual segments are rastered in color separations of predetermined colors;
the color separations are collected at interface computers; and
each of the interface computers is associated with a print group.

14. The method according to claim 13, wherein a page view module that is designed at the main computer controls the readout of the section of the cached rastered print data such that corresponding sections are read out from the respective color separations at the different interface computers.

15. The method according to claim 13, wherein a page view module that is designed at the main computer controls the readout of the section of the cached rastered print data such that corresponding sections are read out from the respective color separations at the different raster computers.

16. The method according to claim 14, wherein the read-out sections of the color separations are merged into a section of a print image before they are transmitted to the display device.

17. The method according to claim 15, wherein the read-out sections of the color separations are merged into a section of a print image before they are transmitted to the display device.

18. The method according to claim 1, wherein the print data language comprises IPDS AFP, PCL, or PS.

19. A production system including multiple components that respectively have a client computer which are connected via data connections with a main computer, software being stored at the main computer and the client computers, that when executed, controls the production system to:
raster a print data stream using a rastering device of the production system, and cache the rastered print data in a print data memory at the production system;
read out a section of the cached rastered print data using a collection process executable at the production system, wherein the collection process receives and executes a request to read out a specific section of the rastered print data;
transmit the readout rastered print data to a display device using a real time-capable communication connection; and
present the rastered print data at the display device.

20. The production system according to claim 19, wherein the production system is a printing system.
